(19) United States
(12) Patent Application Publication
(10) Pub. No.: US 2015/0017311 A1
(43) Pub. Date: Jan. 15, 2015

(54) PARTIAL NEUTRALIZATION OF FREE FATTY ACID MIXTURES WITH POTASSIUM, LIVESTOCK FEED COMPOSITIONS INCLUDING THEM, AND METHODS OF MAKING SAME

(71) Applicant: Milk Specialties Global, Eden Prairie, MN (US)

(72) Inventors: Charles Gordon Soderholm, Mankato, MN (US); Robert Stephen Younker, Genoa, IL (US); Jacob John Albrecht, St. Paul, MN (US); George Edward Wells, Victoria, MN (US)

(21) Appl. No.: 14/321,934

(22) Filed: Jul. 2, 2014

Related U.S. Application Data
(60) Provisional application No. 61/842,147, filed on Jul. 2, 2013.

(51) Int. Cl. A23K 1/16; A23K 1/175; A23K 1/18

(52) U.S. Cl. CPC A23K 1/164; A23K 1/1813; A23K 1/1751
USPC 426/609; 426/635

(57) ABSTRACT

This disclosure describes compositions that include a partially neutralized mixture of free fatty acid and a potassium salt of a fatty acid in which the potassium salt of the fatty acid is present in a molar ratio amount in the range of from about 10% to about 40% of the amount of the free fatty acid based upon the theoretical requirement to accomplish total neutralization of all fatty acid in the composition, animal feed compositions that include such compositions, and methods of preparing such compositions.

### CROSS-REFERENCE TO RELATED APPLICATION

This application claims priority to U.S. Provisional Patent Application Ser. No. 61/842,147, filed Jul. 2, 2013, which is incorporated herein by reference.

### BACKGROUND

Methods for producing mineral soaps are well-known. Soaps are generally made from natural animal or plant fats containing triglycerides that include fatty acids, usually long-chain fatty acids, attached to the glycerol skeleton, which form salts by means of a process of saponification in the presence of bases.

Fatty acids that are commonly part of these triglycerides are long-chain fatty acids such as oleic acid, stearic acid, palmitic acid, myristic acid, lauric acid, linoleic acid, and linolenic acid, or mixtures thereof. Fatty acids with much shorter chains may also be used such as, for example, butyric acid, capric acid, caprylic acid, or caproic acid.

Strong inorganic alkaline metal bases such as, for example, sodium hydroxide or potassium hydroxide are frequently chosen as a base for the saponification reaction. In the production of calcium soaps, calcium oxide (CaO) is added to the fats instead of adding an alkaline metal hydroxide.

Typical of products currently on the market are 100% calcium soaps, such as MEGALAC (Church & Dwight Co., Inc., Ewing, N.J.). These products are 100% salts usually of palm oil or soybean oil fatty acids. Such products are generally made by saponification of triglyceride fats, usually palm oil or soybean oil, with technology that is well-known. The 100% calcium soaps have a very high melt point (and actually decompose before melting) and thus cannot be prilled effectively.

Beyond the problems of creating potassium salts of fatty acids of sufficient nutritive value and digestibility (i.e., relatively high salt/free acid ratio, especially for ruminants), other challenges relate transportation, storage, handling and dispensing, and use in processing. One of the problems associated with free fatty acid mixtures (100% non-salted) is that they tend to have relatively low onset melting points such that they may melt when exposed to elevated ambient temperature such as, for example, when stored in silos, packaged in bags, subjected to the heat associated with processing or milling the material with base particulate feeds, or otherwise transporting the material in a warm environment.

The relatively low onset melting point of a free fatty acid mixture also adversely affects handling and dispensing, as it is more preferable to handle and dispense materials, both as a consumer and in industrial processing, that flow as a relatively dry, non-tacky particulate.

Non-salted, 100% free fatty acid products also can be subject to caking and/or agglomeration when subjected to pressure—e.g., when stored in a silo and/or when packing and/or transported in bags.

Moreover, if one desires to blend or mill a free fatty acid nutritional supplement to produce a particulate livestock feed blend, current free fatty acid products can be subject to melting or liquefaction during processing, making them unsuitable for this type of industrial processing. While 100% salt products have acceptable bulk handling properties and can be pelleted, they cannot be prilled. Also, while 100% calcium salted fatty acid products typically are made from palm oil or soybean oil and with the higher unsaturated fatty acid level, these products have a negative nutritional effect on the rumen relative to the more saturated free fatty acid mixtures.

Finally, a problem specific to potassium supplementation is that attempting to administer potassium in the form of a digestible salt (e.g., potassium carbonate) mixed with a fatty acid or a fatty acid salt of another cation (e.g., calcium or magnesium) is that the potassium carbonate can react with the fatty acid or non-potassium fatty acid salt, respectively.

### SUMMARY

This disclosure describes, in one aspect, a composition that includes a partially neutralized mixture of free fatty acid and a potassium salt of a fatty acid in which the potassium salt of the fatty acid is present in a molar ratio amount in the range of from about 10% to about 40% of the amount of the free fatty acid based upon the theoretical requirement to accomplish total neutralization of all fatty acid in the composition.

In another aspect, this disclosure describes an animal feed composition. Generally, the animal feed composition includes a solid particulate livestock feed material and a partially neutralized solid particulate free fatty acid mixture. The partially neutralized free fatty acid mixture generally includes free fatty acid and a potassium salt of a fatty acid present in an amount in the range of from about 10% to about 40% of the amount of the free fatty acid based upon the theoretical requirement to accomplish total neutralization of all fatty acid in the solid particulate mixture.

In yet another aspect, this disclosure describes a method of producing a partially potassium-neutralized free fatty acid mixture. Generally, the method includes preparing a mixture of a free fatty acid a potassium-containing material, then maintaining the mixture at sufficient temperature and for sufficient amount of time so as to form a mixture of free fatty acid and potassium-neutralized free fatty acid. The potassium-containing basic compound may be present in an amount in the range of from about 10% to about 40% of the amount of a free fatty acid based upon the theoretical requirement to accomplish total neutralization of all of fatty acid in the mixture.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1 is a graph showing a comparison of melt point vs. potassium carbonate content for an exemplary mixture of free fatty acid and potassium salt of fatty acid.

FIG. 2 is a graph showing a comparison of Shore A hardness vs. potassium carbonate content for control compositions and various exemplary mixtures of free fatty acid and potassium salt of fatty acid.

FIG. 3 is a graph showing a comparison of percent free fatty acid vs. percent potassium carbonate for various exemplary mixtures of free fatty acid and potassium salt of fatty acid.

FIG. 4 is a graph showing a comparison of Shore A hardness vs. temperature for control compositions and various exemplary mixtures of free fatty acid and potassium salt of fatty acid.

FIG. 5 is a graph showing a comparison of percent neutralization vs. percent potassium carbonate for various exemplary mixtures of free fatty acid and potassium salt of fatty acid.

FIG. 6 is a graph showing a comparison of melt point vs. percent neutralization for various exemplary mixtures of free fatty acid and potassium salt of fatty acid.

FIG. 7 is a graph showing a comparison of percent free fatty acid vs. percent neutralization for various exemplary mixtures of free fatty acid and potassium salt of fatty acid.

### DETAILED DESCRIPTION OF ILLUSTRATIVE EMBODIMENTS

This disclosure relates to nutritional supplement compositions that may be used for livestock and the like, to a livestock feed mixture containing the nutritional supplement compositions, and to their production and use.

Thus, in one aspect, this disclosure describes a nutritional supplement composition and a livestock feed mixture that includes the supplement composition. Generally, the nutritional supplement compositions include fatty acid mixtures that are partially neutralized with potassium.

In another aspect, this disclosure describes methods of preparing the nutritional supplement composition, methods of preparing the livestock feed mixture, and methods of providing nutrition to livestock. Generally, the method of preparing the nutritional supplement includes partially salting (potassium-salting/neutralizing) free fatty acids so that they can be prilled or flaked, exhibit improved compaction in bulk storage, exhibit improved flow and/or handling properties (flow from bulk bins, through augers, etc.), and/or can be processed through traditional feed pelleting mills to make a pelleted feed. Without wishing to be bound by any particular theory, one or more of these properties can be a result of increased onset melt point and/or hardness at a given temperature, compared to mixture of free fatty acids.

Methods for preparing 100% salts of fatty acids are well-known and typically involve saponification of triglyceride fats and/or oils. In contrast, methods described herein can start with free fatty acids rather than triglycerides, and directly produce a partially salted (i.e., partially neutralized) potassium salt of the starting fatty acid mixture. That is, the starting material can include a fatty acid or fatty acid mixture, which is combined with an amount of a suitable potassium salt effective to provide sufficient potassium cation to the reaction mixture. Suitable potassium salts include, for example, potassium carbonate, potassium bicarbonate, potassium chloride, and/or potassium hydroxide. The product produced by this method exhibits reduced amounts of triglycerides, reduced excess potassium and/or reduced glycerol produced as a byproduct compared to processes that result in products made directly from fats and/or oils. In some embodiments, the methods described herein can start with fatty acids prepared by removing glycerol the triglyceride prior to partial salting.

Thus, in one aspect, this disclosure describes a repeatable, controlled process for partial potassium/neutralization of free fatty acids. Generally, the process involves melting free fatty acids, adding an amount of potassium salt to provide the desired level of neutralization, and maintaining the mixture at sufficient temperature and for sufficient amount of time to form a mixture of free fatty acid and potassium-neutralized free fatty acid.

In one embodiment, the reaction can be maintained at a temperature in the range of 230° F. to 300° F. throughout the reaction, although the reaction may be maintained at a temperature outside of this range. In some embodiments, the temperature may be maintained at a temperature minimum of at least 230° F. such as, for example, at least 240° F., at least 250° F., at least 260° F., or at least 270° F. In some embodiments, the maximum temperature may depend at least in part on the smoke point of the fatty acids being used in the reaction. Thus, the reaction may be maintained at a maximum temperature of, for example, no more than 350° F., no more than 330° F., no more than 320° F., no more than 310° F., no more than 300° F., no more than 290° F., no more than 280° F., no more than 275° F., no more than 270° F., no more than 265° F., or no more than 265° F. In some embodiments, the reaction may be maintained at a temperature within a range having, as endpoints, any minimum temperature listed above and any maximum temperature listed above that is greater than the minimum temperature of the range.

In some embodiments, the reaction can be maintained for a minimum of at least two hours such as, for example, at least three hours or at least four hours. In some embodiments, the reaction may be maintained for a maximum of no more than eight hours such as, for example, no more than six hours, no more than five hours, no more than four hours, or no more than three hours. In some embodiments, the reaction may be maintained for a period of time having endpoints defined by any minimum time listed above and any maximum time listed above that is greater than the minimum time. In some embodiments, the reaction may be maintained for a period of at least two hours to no more than four hours. In one exemplary embodiment, the reaction can be maintained for approximately two hours.

The reaction may be monitored by determining Acid Value (AV) of the material. For example, for a target of 40% potassium/neutralization, the AV at completion would be about 60% of the starting AV (i.e., AV_{final}=0.6×AV_{starting}). As an alternative to a timed reaction, the initial Acid Value (AV) can be obtained by known titration methods and the AV monitored throughout the reaction until AV value levels out (e.g. initial AV=185; for 40% potassium/neutralization final AV=111).

Once the reaction is complete, the product material may be further processed such as, for example, prilled in a prilling (spray chilling) tower or flaked on a rotary drum flaker. Alternatively, the mixture may be poured about two hours after addition of the K₂CO₃ and placed in a freezer for ten minutes to set.

The process described herein can produce a partial potassium salt of a fatty acid (or partial potassium salts of fatty acids in a mixture) that exhibit desirable properties for handling, transport and use. In contrast, free fatty acid products may exhibit undesirable flow characteristics, may be difficult to handle or use in bulk, and cannot be pelleted. On the other hand, 100% salt products cannot be prilled and typically have a negative nutritional effect on the rumen compared to mixtures that contain more saturated free fatty acid.

The free fatty acid may be selected from any suitable tallow fatty acids, non-tallow fatty acids, and mixtures thereof. Suitable non-tallow fatty acids can include, for example, palm oil, soy oil, fish oil, linseed oil, flax oil, and mixtures thereof. In some embodiments, the composition may be formulated with a mixture of free fatty acids such as, for example, stearic acid, palmitic acid, myristic acid, lauric, pentadecanoic, palmitoleic, margaric, oleic, linoleic, linolenic, and/or arachidic. For example, one exemplary embodiment can be prepared from a blend of stearic acid (56 wt %), palmitic acid (38 wt %), myristic acid (2.5 wt %) and heptadecanic acid (1.5 wt %).

In some embodiments, the mixture can be prepared using a mixture of tallow fatty acids and vegetable fatty acids to produce the potassium salts thereof, although the invention may be produced or practiced using any fatty acid or fatty acid mixture. When using certain fatty acid mixtures with relatively lower melting temperatures (i.e., softer mixtures), one may use a greater amount of potassium. In some embodiments, the free fatty acids can include those having a degree of unsaturation such that the iodine number is no greater than 20 such as, for example, no greater then 16, no greater than 12, no greater than 10, no greater than 8, no greater than 7, no greater than 6, no greater than 5, no greater than 4, no greater than 3, no greater than 2, or no greater than 1. In some embodiments, the free fatty acids can include those having a degree of unsaturation such that the iodine number is no greater than 10. In another embodiment, the free fatty acids can include those having a degree of unsaturation such that the iodine number is no greater than 8. In another embodiment, the free fatty acids can include those having a degree of unsaturation such that the iodine number is no greater than 5. In another embodiment, the free fatty acids can include those having a degree of unsaturation such that the iodine number is no greater than 3. In another embodiment, the free fatty acids can include those having a degree of unsaturation such that the iodine number is no greater than 2. In another embodiment, the free fatty acids can include those having a degree of unsaturation such that the iodine number is no greater than 1.

Potassium may be incorporated in any form adapted to form the salt (or salts) of the fatty acid (or fatty acids), broadly in an amount equivalent to provide from about 10% to about 40% neutralization. Within range of from about 10% neutralization to about 40% neutralization, potassium may be incorporated in an amount to provide a minimum of at least 10% neutralization, at least 15% neutralization, at least 20% neutralization, at least 25% neutralization, at least 30% neutralization, or at least 35% neutralization. Within range of from about 10% neutralization to about 40% neutralization, potassium may be incorporated in an amount to provide a maximum of no more than 40% neutralization, no more than 35% neutralization, no more than 30% neutralization, no more than 25% neutralization, no more than 20% neutralization, or no more than 15% neutralization. In some embodiments, potassium may be incorporated in an amount to provide a percent neutralization (% neutralization) within a range having as endpoints any minimum % neutralization listed above and any maximum % neutralization greater than the selected minimum % neutralization.

The melt point and hardness of the composition may be a function of the percent of potassium salting—i.e., percent neutralization. In some embodiments, the onset melt point may be a minimum temperature of at least 130° F. such as, for example, at least 140° F., at least 150° F., at least 160° F., at least 170° F., at least 180° F., at least 190° F., at least 200° F., or at least 210° F. The onset melt point may be a maximum temperature of no more than 220° F. such as, for example, no more than 210° F., no more than 200° F., no more than 190° F., no more than 180° F., no more than 170° F., no more than 160° F., or no more than 150° F. In some embodiments, the onset melt point may fall within a range having as endpoints any minimum onset melt point listed above and any maximum onset melt point greater than the selected minimum onset melt point. In certain embodiments, the onset melt point may be, for example, 170° F.

In some embodiments, the composition can exhibit a maximum Shore A hardness no more than 15 at 170° F. such as, for example, no more than 12, no more than 10, no more than 8, or no more than 5 at 170° F. In some embodiments, the composition can exhibit a Shore A hardness of at least 2 at 170° F. such as, for example, at least 3, at lease 4, at least 5, at least 7, or at least 10 at 170° F. In some embodiments, the composition can exhibit a Shore A hardness within a range having as endpoints any maximum Shore A hardness listed above and any minimum Shoe A hardness that is less than the selected maximum Shore A hardness. In some embodiments, the composition may exhibit a Shore A hardness of 5-10 at 170° F. In other embodiments, the composition can exhibit a Shore A hardness of at least 15 at a temperature less than 170° F. (e.g., Shore A of 15 at 150° F. or a Shore A hardness of 90 at room temperature (70° F.)) can yield good commercially important improved properties.

Some of the properties exhibited by the partially neutralized fatty acid mixtures described herein include, for example, that it may be stored, transported and used in bulk with limited compaction and/or disadvantageous liquefaction. In contrast, comparable products such as, for example, mixtures of free fatty acids from tallow, palm and/or soy cannot.

As one measure of the compressibility of the partially neutralized fatty acid mixtures described herein, a 50-100 gram weight at 50° C. for 1 hour (about 2 psi-4 psi) did not result in compaction sufficient to restrict the ability of the flaked or prilled product to be poured.

The partially neutralized fatty acid mixtures described herein also can feature controllable, increased onset melt point and controllable, increased hardness at all temperatures relative to free fatty acid mixtures. The methods described herein thus offer one the ability to control and/or manipulate the onset melt point of the composition.

While a 100% calcium salt of a free fatty acid mixture of, for example, oils like palm oil and soy (which are liquid at room temperature) produces a solid product that has good flow properties and can be pelleted, the unsaturated fatty acids present in palm and soy have a negative effect on the rumen, which limits the dose that can be fed to dairy cattle. Also, while mixtures of tallow fatty acids—with a lower degree of saturation compared to palm oil and soy and thus are solids at ambient temperature—can be prilled, they do not have good flow properties and cannot be pelleted.

A partially salted potassium salt of a fatty acid mixture is a complex mixture of lower melting fatty acids and non-melting potassium salts. It is surprising that partially neutralized potassium fatty acid mixtures exhibit an increase in onset melt point rather than the non-salted fatty acids melting at their normal melt point and the potassium salts being suspended in the matrix of fatty acids. The potassium salts of a fraction of the free fatty acids present seem to complex with the remaining free fatty acids to form a mixture that has an increased onset melt point. This increase in melt point was discovered to be positive and non-linear with increasing percent potassium.

Similarly, it is surprising that the partially salted potassium fatty acids exhibit improved hardness relative to the free fatty acids. By increasing the degree of salting by increasing the percent of potassium salts of the fatty acids present, however, one can form a mixture that is harder (as measured by Shore A) at any given temperature up to the melt point relative to free fatty acid mixtures. This increase as with onset melt point is also non-linear.

The partially salted fatty acid mixture of the present invention may be prilled or flaked, in accordance with methods known and used in the art.

The compositions described above may be prepared as a component of a livestock feed product that may be suitable for bulk storage such as, for example, in a silo or otherwise. The livestock feed product may, alternatively, be bagged for storage and/or transported in relatively warmer environments in which free fatty acid mixtures may be susceptible to melting. The product can be used as a feed supplement and may be formulated into fat supplementing animal feeds for, for example, livestock and/or companion animals such as, for example, dairy cows, beef cows, cattle, horses, dogs, etc. The animal feeds may be rendered into particulate or pelletized form using conventional methods and equipment.

Thus, in another aspect, this disclosure describes a feed supplement that can increase the fat intake level of animals. The feed supplement may be added to animal feed and administered to an animal. The animal feed typically may be a dry feed.

The feed supplement may be used for pelleted feed applications while comparable feed supplements prepared from mixtures of free fatty acids such as, for example, tallow, palm or soy cannot be pelleted. Moreover, the feed supplement may stored, transported, and used in dairies in hot climates (e.g., Florida, Arizona and New Mexico) while comparable feed supplements cannot be handled in these climates without adverse effects on their physical form.

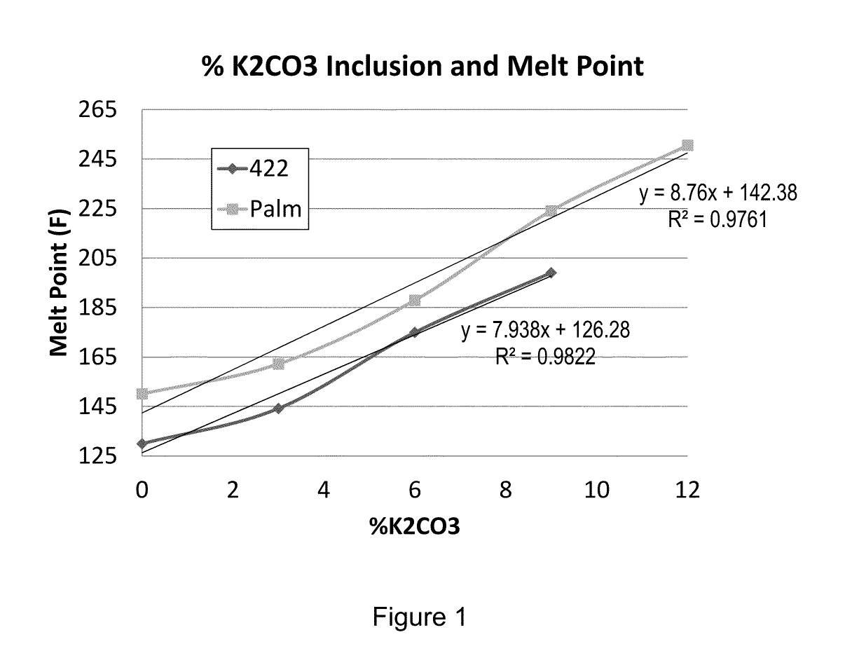

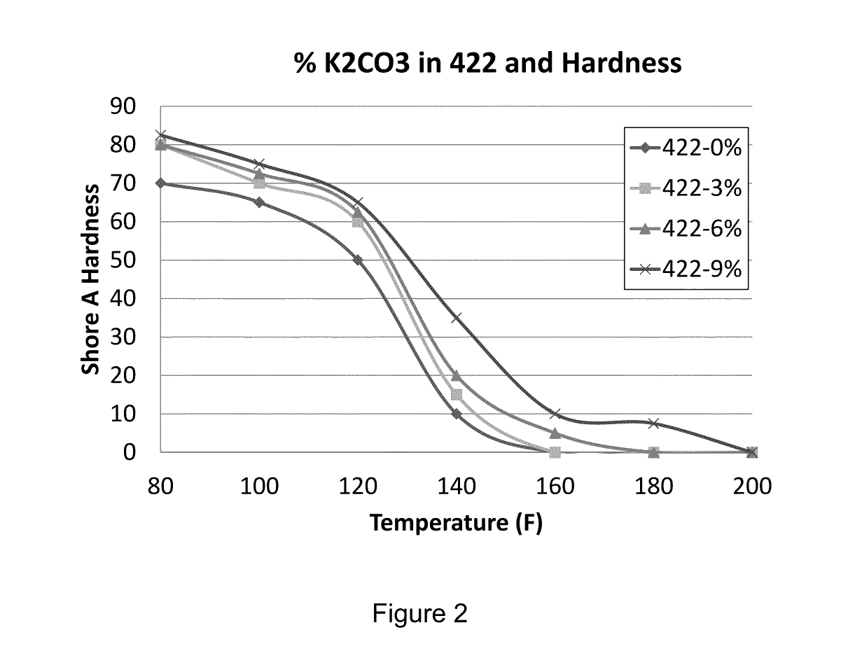

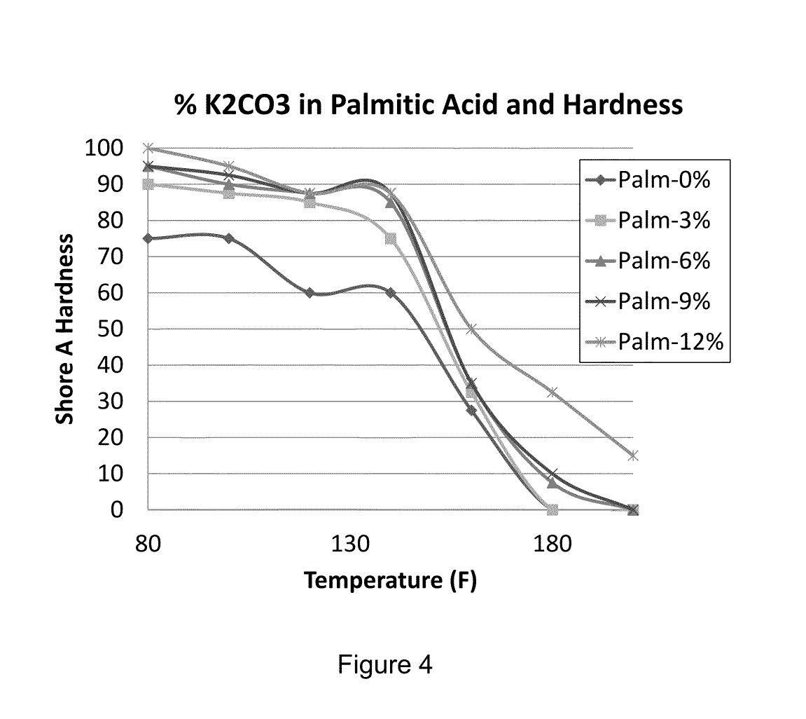

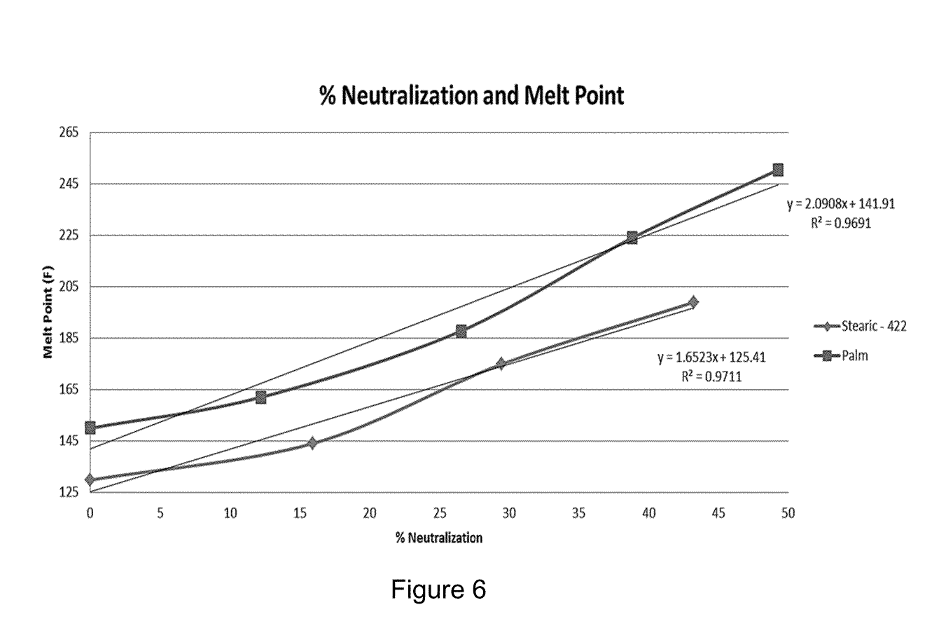

For example, the data presented in FIG. 2 and FIG. 4 demonstrate that the hardness of the product is sufficient for easy handling, transportation and administration to animals. Moreover, the hardness data suggest that the product's hardness may be maintained at acceptable levels between about 3% and about 9% K₂CO₃. Moreover, the data in FIG. 1 and FIG. 6 show that the melt point of the compositions may be raised by using progressively higher amounts of potassium to a level effective to reduce melting during handling, shipping, and processing.

Thus, partial salting with potassium can provide a product with handling characteristics similar to those of 100% calcium or magnesium salts. Moreover, partial salting with potassium allows the melting point to be raised and the composition hardened, thus improving handling.

Also, during hot weather it can be desirable to feed saturated free fatty acids (SFFAs) and potassium carbonate to dairy cows, as they require the SFFAs for energy (due to reduced intakes) and the potassium carbonate to offset increased potassium loss due to sweating. In the past these two frequently used ingredients have needed to be kept separate as the potential of the potassium carbonate to react with the fatty acid in an uncontrolled manner to produce an unusable reaction product was always a concern. By reacting the SFFA and potassium carbonate under controlled conditions prior to mixing in feedstuffs, the undesired post-mixing “reaction” can be eliminated.

In yet another embodiment, this disclosure describes a method of providing nutrition to an animal. Generally, the method includes feeding to the animal a mixture containing a partially potassium-neutralized free fatty acid mixture described herein.

The term “and/or” means one or all of the listed elements or a combination of any two or more of the listed elements; the terms “comprises” and variations thereof do not have a limiting meaning where these terms appear in the description and claims; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

In the preceding description, particular embodiments may be described in isolation for clarity. Unless otherwise expressly specified that the features of a particular embodiment are incompatible with the features of another embodiment, certain embodiments can include a combination of compatible features described herein in connection with one or more embodiments.

For any method disclosed herein that includes discrete steps, the steps may be conducted in any feasible order. And, as appropriate, any combination of two or more steps may be conducted simultaneously.

### EXAMPLES

Exemplary embodiments of various aspects of the invention are illustrated by the following examples. It is to be understood that the particular examples, materials, amounts, and procedures are to be interpreted broadly in accordance with the scope and spirit of the invention as set forth herein. The examples are chosen and described to explain the principles of the invention and the application of the method to practical uses so that others skilled in the art may practice the invention.

### Example 1

### Preparation of Partially Neutralized Fatty Acid Mixtures

A mixture of free fatty acids (0-4% myristic, 30-99% palmitic, 0-2% margaric, 0-50% stearic, 0-10% oleic, 0-2% linoleic, 0-1% arachidic) was heated to about 230° F. Potassium carbonate was added to provide the desired neutralization equivalents of potassium. The potassium carbonate was added at a rate of 1% to 2% K₂CO₃ every 10 minutes until all of the potassium carbonate was added. The exothermic reaction of potassium carbonate with free fatty acids caused the temperature to rise when added and mixed. The reaction was held at about 230° F. until complete as measured by leveling off a greater than 55% free fatty acid (110 AV).

The reacted mixture is then cooled to crystallize/set.

### Example 2

### Testing

Prilled fats (Steric acid-422 with 0%, 3%, 6%, or 9% K₂CO₃, or palmitic acid with 0%, 3%, 6%, 9%, or 12% K₂CO₃) were prepared as described in Example 1. Each sample was melted in an aluminum moisture pan on a hot plate until the sample became a uniform liquid. Once completely melted, the container was cooled in a chilled ethanol/water to −20° F. in a freezer until the fats solidified. The sample “puck” was placed upside down in pan to expose smooth side for testing with Shore-A-Hardness durometer (Rex Gauge Co., Buffalo Grove, Ill.).

A small wedge of the sample puck was broken off and placed on a filter pad in another pan for melt point determination.

The remaining sample puck was placed in an oven (Cole-Parmer, Vernon Hills, Ill.) and heated to 80° F., then held at 80° F. for 15 minutes. The heated sample was removed from the oven and the hardness was tested using the durometer.

The sample was returned to the oven, heated to 100° F., held at 100° F. for 15 minutes, then removed from the oven and the hardness was tested using the durometer. This process was repeated in 20° F. increments at 15 minute intervals until the sample hardness was less than 5 or until the filter pad melted.

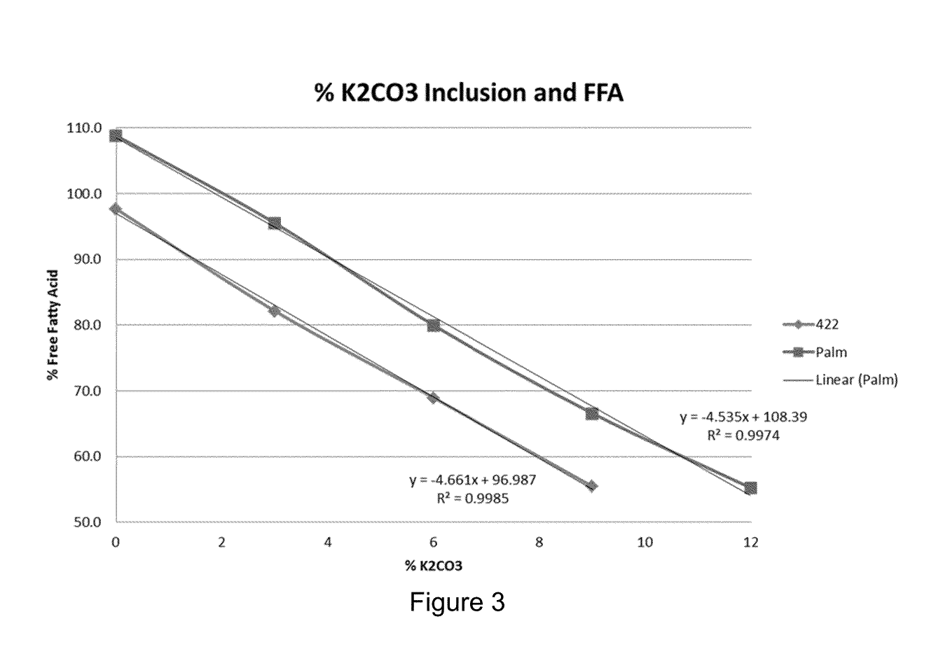

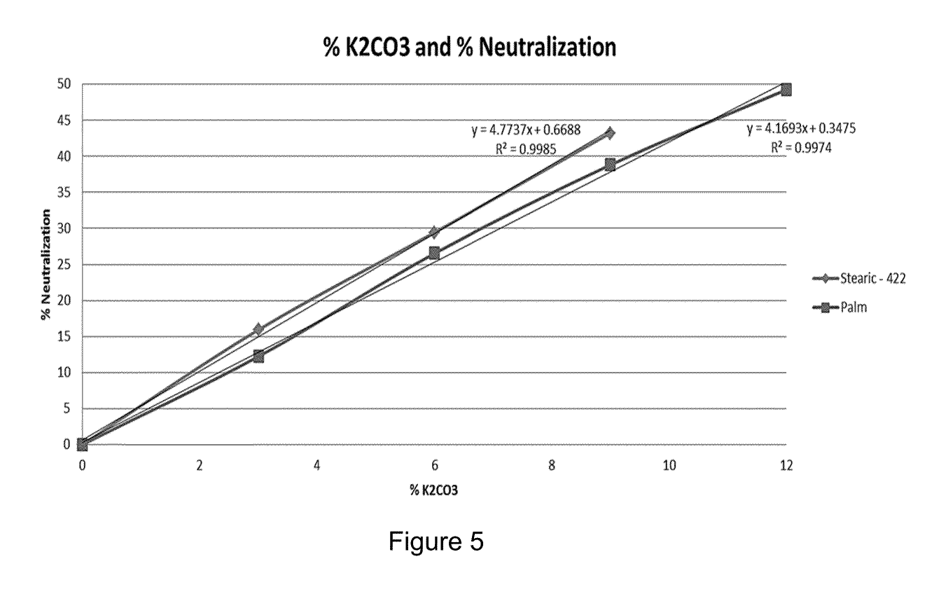

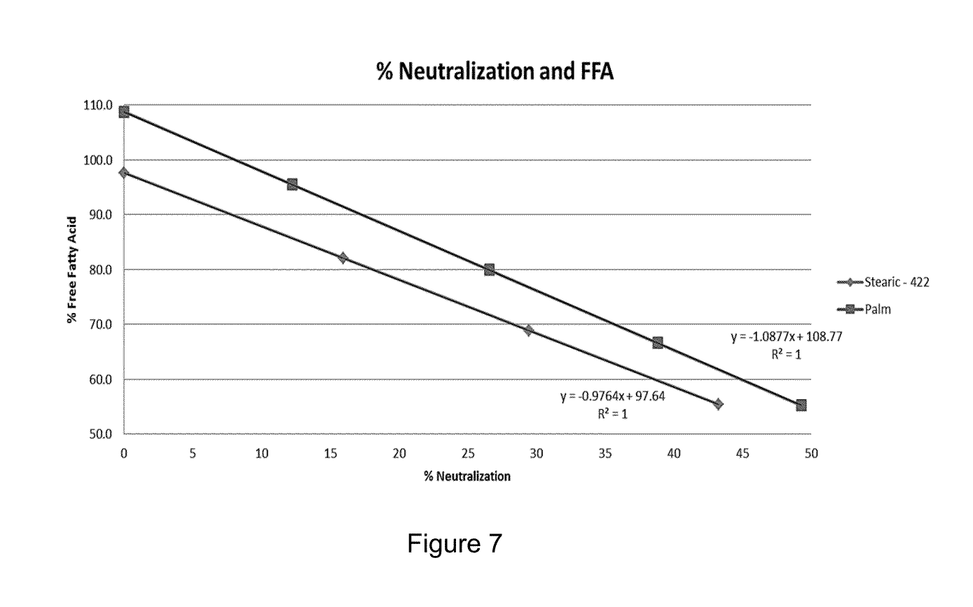

Results are shown in Table 1 and FIGS. 1-7.

The data presented in FIG. 2 and FIG. 4 demonstrates that the hardness of the product is sufficient for easy handling, transportation and administration to animals. Moreover, the hardness data suggest that the product's hardness may be maintained at acceptable levels between about 3% and about 9% K₂CO₃.

The data in FIG. 1 and FIG. 6 show that the melt point of the compositions may be raised by using progressively higher amounts of potassium to a level effective to reduce melting during handling, shipping, and processing.

TABLE 1

| | | Melt | | % Free | Hardness (Shore A) | | | | | | |
|---|---|---|---|---|---|---|---|---|---|---|---|
| | % K | (° F.) | % Neut. | fatty acid | 80° F. | 100° F. | 120° F. | 140° F. | 160° F. | 180° F. | 200° F. |
| Steric | 0 | 130 | 0 | 97.6 | 70 | 65 | 50 | 10 | 0 | 0 | 0 |
| | 3 | 144 | 16 | 82.1 | 80 | 70 | 60 | 15 | 0 | 0 | 0 |
| | 6 | 175 | 29 | 68.9 | 80 | 72.5 | 62.5 | 20 | 5 | 0 | 0 |
| | 9 | 199 | 43 | 55.4 | 82.5 | 75 | 65 | 35 | 10 | 7.5 | 0 |
| Palm | 0 | 150 | 0 | 108.8 | 75 | 75 | 60 | 60 | 27.5 | 0 | 0 |
| | 3 | 162 | 12 | 95.5 | 90 | 87.5 | 85 | 75 | 32.5 | 0 | 0 |
| | 6 | 188 | 27 | 79.9 | 95 | 90 | 87.5 | 85 | 35 | 7.5 | 0 |
| | 9 | 224 | 39 | 66.6 | 95 | 92.5 | 87.5 | 87.5 | 35 | 10 | 0 |
| | 12 | 251 | 49 | 55.2 | 100 | 95 | 87.5 | 87.5 | 50 | 32.5 | 15 |

The complete disclosure of all patents, patent applications, and publications, and electronically available material (including, for instance, nucleotide sequence submissions in, e.g., GenBank and RefSeq, and amino acid sequence submissions in, e.g., SwissProt, PIR, PRF, PDB, and translations from annotated coding regions in GenBank and RefSeq) cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A composition comprising:
a solidified particulate mixture of free fatty acid and a potassium salt of a fatty acid, the potassium salt of a fatty acid being present in a molar ratio amount in the range of from about 10% to about 40% of the amount of the free fatty acid based upon the theoretical requirement to accomplish total neutralization of all fatty acid in the composition.

2. The composition of claim 1, wherein the free fatty acid comprises tallow fatty acid, and the potassium salt of a fatty acid comprises a potassium salt of a tallow fatty acid.

3. The composition of claim 1 wherein the free fatty acid comprises non-tallow fatty acids.

4. The composition of claim 3 wherein the non-tallow fatty acids comprise palm oil, soy oil, fish oil, linseed oil and flax oil, or a mixture thereof.

5. The composition of claim 1 wherein the mixture comprises potassium equivalent to potassium carbonate present in an amount of from about 3% to about 9%.

6. An animal feed composition comprising:
a solid particulate livestock feed material; and
a solid particulate mixture comprising:
free fatty acid; and
a potassium salt of a fatty acid present in an amount in the range of from about 10% to about 40% of the amount of the free fatty acid based upon the theoretical requirement to accomplish total neutralization of all fatty acid in the solid particulate mixture.

7. The animal feed composition of claim 6 wherein:
the free fatty acid comprises tallow fatty acid; and
the potassium salt of a fatty acid comprises a potassium salt of a tallow fatty acid.

8. The animal feed composition of claim 6 wherein the free fatty acid comprises non-tallow fatty acids.

9. The animal feed composition of claim 8 wherein the non-tallow fatty acids comprise palm oil, soy oil, fish oil, linseed oil and flax oil, or a mixture thereof.

10. A method of producing a partially potassium-neutralized free fatty acid mixture, the method comprising:
preparing a mixture of:
an amount of a free fatty acid; and
an amount of a potassium-containing material comprising a potassium-containing basic compound present in an amount in the range of from about 10% to about 40% of the amount of a free fatty acid based upon the theoretical requirement to accomplish total neutralization of all of fatty acid in the mixture; and
maintaining the mixture at sufficient temperature and for sufficient amount of time so as to form a mixture of free fatty acid and potassium-neutralized free fatty acid.

11. The method of claim 10 wherein the free fatty acid comprises tallow.

12. The method of claim 10 wherein the free fatty acid comprises a mixture of stearic acid, palmitic acid, myristic acid and heptadecanic acid.

13. The method of claim 10 wherein the free fatty acid comprises non-tallow fatty acids.

14. The method of claim 13 wherein the non-tallow fatty acids comprise palm oil, soy oil, fish oil, linseed oil and flax oil, or a mixture thereof.

15. The method of claim 10 wherein the mixture is maintained at a temperature in the range of from about 210° F. to about 300° F.

16. The method of claim 10 further comprising prilling the mixture.

17. The method of claim 10 further comprising flaking the mixture.
